(19) United States
(12) Patent Application Publication
(10) Pub. No.: US 2022/0266265 A1
(43) Pub. Date: Aug. 25, 2022

(54) CYCLONE SPEARATION DEVICE AND CLEANING EQUIPMENT

(71) Applicant: FORNICE INTELLIGENT TECHNOLOGY CO., LTD, Guangdong (CN)

(72) Inventors: Zhan CAI, Guangdong (CN); Liwen ZHU, Guangdong (CN)

(73) Assignee: FORNICE INTELLIGENT TECHNOLOGY CO., LTD, Guangdong (CN)

(21) Appl. No.: 17/284,477

(22) PCT Filed: Sep. 4, 2020
(86) PCT No.: PCT/CN2020/113447

§ 371 Date: Dec. 6, 2021

(30) Foreign Application Priority Data
Sep. 2, 2020 (CN) 202010910013.8

(51) Int. Cl. B04C 5/103; B04C 5/04; B04C 5/13; B04C 5/28; A47L 9/16

(52) U.S. Cl. CPC B04C 5/103; B04C 5/04; B04C 5/13; B04C 5/28; A47L 9/1608; A47L 9/1641; A47L 9/165; A47L 9/1658

(57) ABSTRACT

The disclosure discloses a cyclonic separating apparatus and a cleaning appliance. The cyclonic separating apparatus includes a downstream cyclonic separating assembly which includes at least one cyclonic separator ring including a plurality of cyclonic separators. Each of the cyclonic separators includes a cyclonic separating drum having an upper side edge communicating with a tangential air duct and a curved duct arranged in an upper portion of the cyclonic separating drum and communicating with the tangential air duct. A spiral rise angle of the curved duct is greater than a half cone angle of an inverted cone drum of the cyclonic separating drum.

### BACKGROUND

### Technical Field

The present disclosure relates to the technical field of cyclonic separation, and in particular to a cyclonic separating apparatus and a cleaning appliance.

### Description of Related Art

Cleaning appliances with cyclonic separating apparatus, such as vacuum cleaners, are known in the prior art. Generally, in a cyclonic vacuum cleaner, air carrying dirt and dust enters a first cyclonic separator through a tangential inlet, and the dirt is separated under the action of a centrifugal force into a collecting cavity. Cleaner air flows out from the collecting cavity to enter a second cyclonic separator which can separate finer dirt, dust and other particles compared with the first cyclonic separator. The existing second cyclonic separator mainly includes a cyclonic separating drum and an overflow drum. There is a suitable space between the cyclonic separating drum and the overflow drum so that dust-containing gas forms a rotating airflow zone therebetween, and particles with large mass are thrown towards a drum wall under the action of a centrifugal force. The gas forms a vortex, flows to an inner drum with a lower pressure, and finally is discharged upward from the overflow drum, which plays a role in dust removal and purification.

Existing vacuum cleaners with two-stage cyclonic separation mainly focus on how to improve separation effects of dust particles from air. For example, a vacuum cleaner is disclosed in a Chinese patent (publication No. CN105030148A, published on Nov. 11, 2015), and a cyclonic separating apparatus is disclosed in a Chinese patent (publication No. CN101816537, published on Sep. 1, 2010). However, the inventor found that although the existing two-stage cyclonic separation can effectively improve the separation effects of dust from air, a cyclonic separating drum of a downstream cyclonic separating assembly accumulates a large amount of dust, and there is also dust accumulation outside the overflow drum. The main reason is that the separated dust is difficult to be discharged only by its own gravity to a dust outlet, resulting in accumulation of a large amount of dust in a cyclonic separating outer drum and further a possibility of back mixing and diffusion to escape to the outside of the overflow drum. Therefore, how to discharge the particles separated timely and quickly to the dust outlet is a technical problem in the prior art.

### SUMMARY

In order to solve the above problem, the present disclosure provides a cyclonic separating apparatus and a cleaning appliance.

In order to achieve the above objectives, the present disclosure adopts the following technical solutions.

A cyclonic separating apparatus includes a downstream cyclonic separating assembly, which includes at least one cyclonic separator ring, each of which includes a plurality of cyclonic separators. Each of the cyclonic separators includes as follows.

The cyclonic separating drum has an upper side edge communicating with a tangential air duct through which air with particles is guided to form an airflow that is consistent with a direction of the tangential air duct and then tangentially enters the cyclonic separating drum to form a rotating airflow.

The curved duct is arranged in an upper portion of the cyclonic separating drum and communicates with the tangential air duct. A spiral rise angle λ of the curved duct is greater than a half cone angle a of an inverted cone drum of the cyclonic separating drum, such that after the rotating airflow enters the curved duct, a direction of a centripetal force of the rotating airflow is changed to above a side of a direction of a support force of a drum wall of the cyclonic separating drum.

As a preferred embodiment of the cyclonic separating apparatus provided by the present invention, a lead of the curved duct is set to be less than one.

As a preferred embodiment of the cyclonic separating apparatus provided by the present invention, the tangential air duct has an airflow guide path.

As a preferred embodiment of the cyclonic separating apparatus provided by the present invention, an outer side wall of the tangential air duct is a planar side wall, and is tangent to a side edge of a cylindrical drum of the cyclonic separating drum; or, the outer side wall of the tangential air duct is a curved side wall, and is tangent to the side edge of the cylindrical drum of the cyclonic separating drum.

As a preferred embodiment of the cyclonic separating apparatus provided by the present invention, an inner side wall of the tangential air duct is a planar side wall or a curved side wall.

As a preferred embodiment of the cyclonic separating apparatus provided by the present invention, each of the cyclonic separators further includes an overflow drum which is coaxially arranged in the upper portion of the cyclonic separating drum and serves as an exhaust outlet. The curved duct is located in a region between the cyclonic separating drum and the overflow drum.

As a preferred embodiment of the cyclonic separating apparatus provided by the present invention, the curved duct is arranged on the drum wall of the cyclonic separating drum or the curved duct is arranged on an outer wall of the overflow drum.

As a preferred embodiment of the cyclonic separating apparatus provided by the present invention, two side walls of the tangential air duct or extension surfaces of the tangential air duct are respectively tangent to the cyclonic separating drum and the overflow drum.

As a preferred embodiment of the cyclonic separating apparatus provided by the present invention, each of the cyclonic separators further comprises a diversion inclined wall corresponding to an upper portion of the tangential air duct.

A cleaning appliance includes the cyclonic separating apparatus as described above.

The inventor of the present disclosure combines the tangential air duct with the specific curved duct, and unexpectedly finds that after use for a period of time, there is basically no dust accumulation on the drum wall of the cyclonic separating drum, that is, the cyclonic separating apparatus of the present disclosure can effectively can effectively discharge the particles separated to the outside of the dust discharge port timely and quickly, not only solve the technical problem described in the background, but also avoid possibility of back mixing and diffusion caused by the particles accumulated, and meanwhile ensure that the cyclonic separating drum is in a clean state without particle accumulation to help to improve separation and purification effect as well as prolong the service life.

After analysis, the inventor considers that when the airflow is rotating, the particles in the airflow only suffer from the support force (a resultant force) provided by one drum wall in the case of ignoring the influence of gravity. Due to the presence of rotating motion, the support force (the resultant force) is inevitably decomposed into a centripetal force (a first component) perpendicular to a rotating axis and the other second component. In order to ensure the decomposition balance of the resultant force, the first component force and the second component force need to exist on both sides of the support force (the resultant force) to ensure the decomposition balance of the resultant force. By the curved duct such that the direction of the centripetal force of the rotating airflow deflects from an original direction perpendicular to the rotating axis and forms an upward included angle with the direction of the support force FN of the drum wall of the cyclonic separating drum, that is, the direction of the centripetal force (the first component force) of the rotating airflow is changed to above the side of the direction of the support force of the drum wall of the cyclonic separating drum, and the direction of the second component force in balance with the centripetal force (the first component force) is adjusted to be downward, which is conductive to making the particles flow to the outside of the dust discharge port under the traction of the downward component force (the second component force). Therefore, the cyclonic separator of the present invention combines the tangential air duct with the curved duct, which can effectively discharge the separated particles to the outside of the dust discharge port timely and quickly, not only solve the technical problem described in the above background, but also avoid the possibility of back mixing and diffusion caused by the accumulated particles, and meanwhile, ensure that the cyclonic separating drum is in the clean state without dust accumulation to help to improve the separation and purification effect and prolong the service life.

If there is no curved duct, the direction of the centripetal force (the first component force F1′) of the rotating airflow does not change, i.e., below the direction of the support force of the drum wall. Then, according to the decomposition balance of the resultant force, the second component force F2′ in balance with the first component force F1′ is always upwards, then the particles does not suffer from any acting force for being discharged from the cyclonic separating drum, and the particles that cannot be discharged can only accumulate on the drum wall of the cyclonic separating drum.

### BRIEF DESCRIPTION OF THE DRAWINGS

FIG. 1 is a structural schematic diagram of a cyclonic separating apparatus in Embodiment 1 of the present disclosure;

FIG. 2 is a structural schematic diagram of a downstream cyclonic separating assembly in Embodiment 1 of the present disclosure;

FIG. 3 is a structural schematic diagram of a cyclonic separator in Embodiment 1 of the present disclosure;

FIG. 4 is an exploded schematic diagram of FIG. 3;

FIG. 5 is an exploded schematic diagram of the cyclonic separator in another state of Embodiment 1 of the present disclosure;

FIG. 6 is a partial sectional view of the cyclonic separator of Embodiment 1 of the present disclosure, in which a sectional view of a cylindrical drum and an inverted cone drum is shown;

FIG. 7 is a schematic diagram of stress analysis of particles in a rotating airflow without a redirecting duct in the prior art;

FIG. 8 is a schematic diagram of stress analysis of particles in a rotating airflow with a redirecting duct of Embodiment 1 of the present disclosure;

FIG. 9 is a schematic diagram of stress analysis of particles in the rotating airflow with the redirecting duct of Embodiment 1 of the present disclosure;

FIG. 10 is a structural schematic diagram of a cyclonic separating drum and a tangential air duct in Embodiment 1 of the present disclosure;

FIG. 11 is a schematic diagram of an implementation state of an overflow drum with a curved duct in Embodiment 1 of the present disclosure;

FIG. 12 is a schematic diagram of another implementation state of the overflow drum with the curved duct in Embodiment 1 of the present disclosure;

FIG. 13 is a schematic diagram of another implementation state of the overflow drum with the curved duct in Embodiment 1 of the present disclosure;

FIG. 14 is an exploded schematic diagram of the downstream cyclonic separating assembly in Embodiment 1 of the present disclosure;

FIG. 15 is a schematic diagram of a cyclonic separator support, a cyclonic separating drum and a tangential air duct in Embodiment 1 of the present disclosure;

FIG. 16 is a sectional view of the downstream cyclonic separating assembly in Embodiment 1 of the present disclosure;

FIG. 17 is another exploded schematic diagram of the downstream cyclonic separating assembly in Embodiment 1 of the present disclosure;

FIG. 18 is an exploded schematic diagram of FIG. 1; and

FIG. 19 is a sectional view of FIG. 1 in which thick solid lines and thick dashed lines with arrows indicate airflow paths.

### DESCRIPTION OF THE EMBODIMENTS

In order to enable those skilled in the art to better understand the solutions of the present disclosure, the technical solutions of the embodiments of the present disclosure will be described clearly and comprehensively with reference to the accompanying Drawings of the embodiments of the present disclosure. Obviously, the described embodiments are only part of the embodiments of the present disclosure instead of all of the embodiments. Based on the described embodiments of the present disclosure, all other embodiments obtained by those skilled in the art without creative labor should fall within the protection scope of the present disclosure.

### Embodiment 1

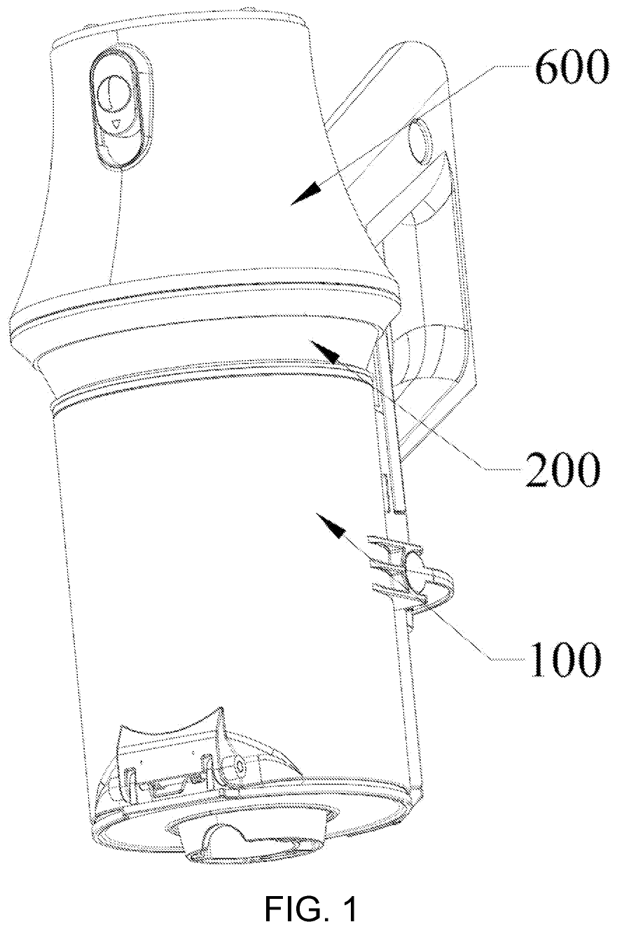

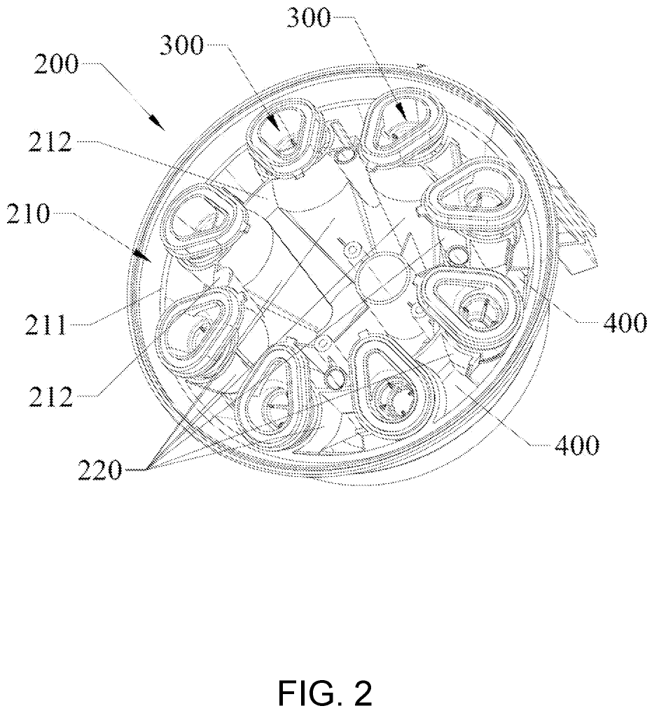

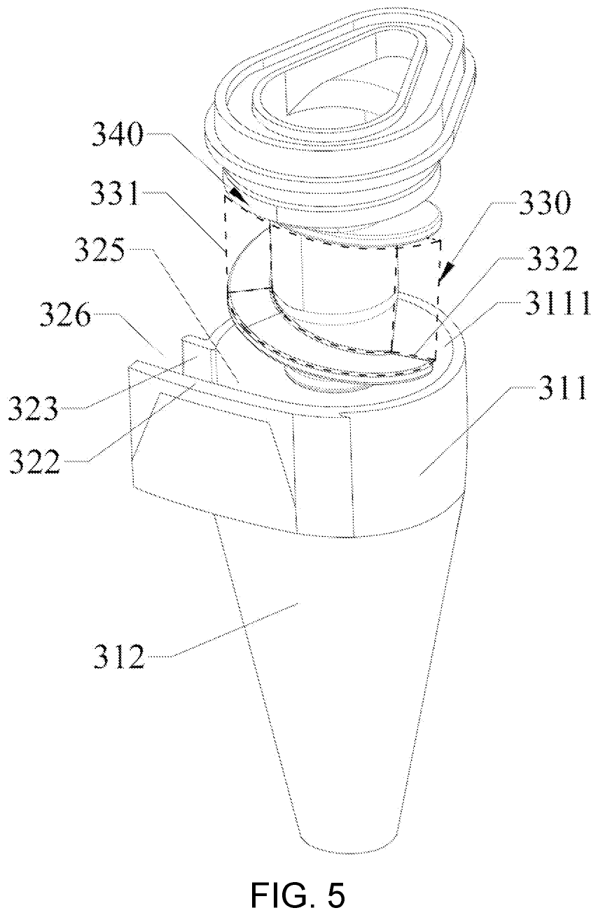

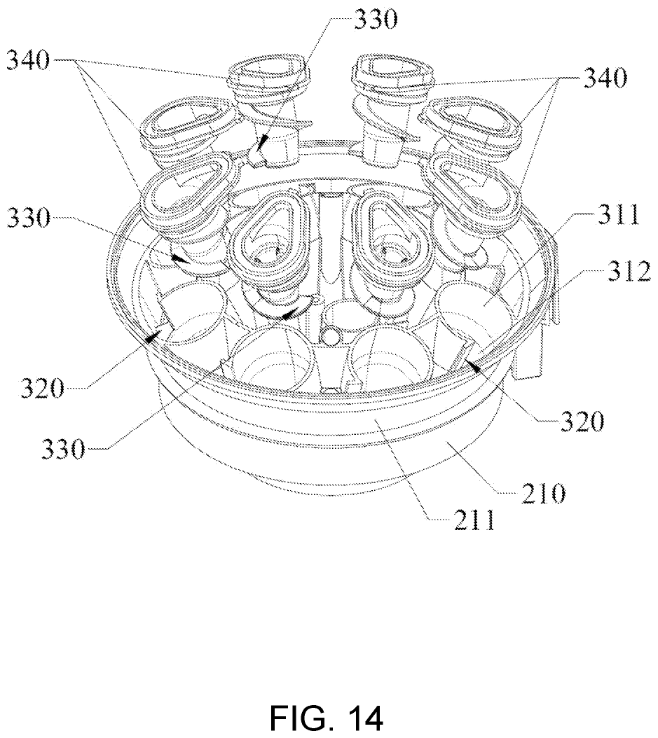

In view of the technical problems in the prior art, referring to FIGS. 1-19, the present invention provides a cyclonic separating apparatus, which includes an upstream cyclonic separating assembly 100 and a downstream cyclonic separating assembly 200. The upstream cyclonic separating assembly 100 communicates with the downstream cyclonic separating assembly 200 by an air guide path. The downstream cyclonic separating assembly 200 includes a cyclonic separator support 210 and at least one cyclonic separator ring 220, which is located in the cyclonic separator support 210. Each cyclonic separator ring 220 includes a plurality of cyclonic separators 300.

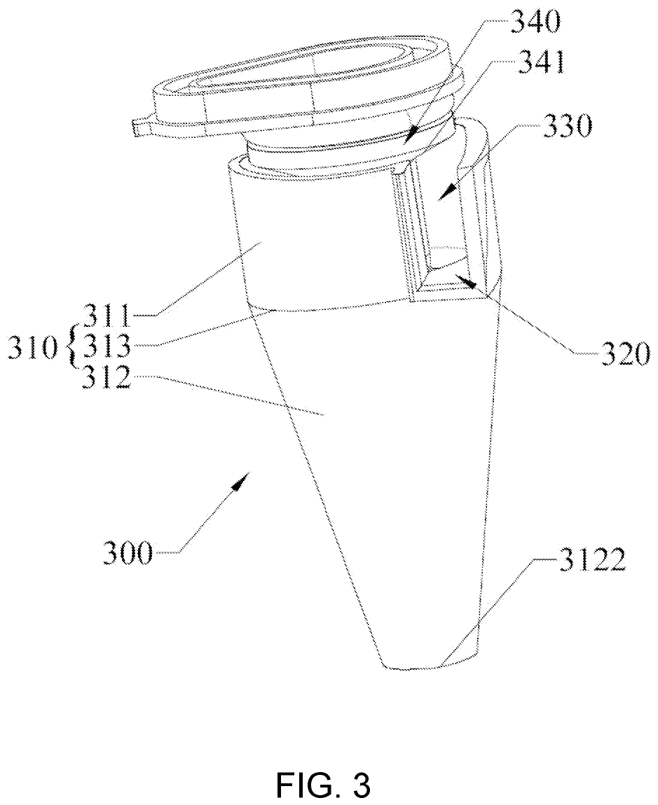

Specifically, referring to FIGS. 3-13, each of the cyclonic separators 300 includes as follows.

The cyclonic separating drum 310 has an upper side edge communicating with a tangential air duct 320. The tangential air duct 320 has an airflow guide path and is tangent to a side edge of the cyclonic separating drum 310 to guide air with particles to form an airflow consistent with a direction of the tangential air duct 320, and then the airflow tangentially enters the cyclonic separating drum 310 to form a rotating airflow, i.e., a cyclonic airflow.

The curve duct 330 is arranged in an upper portion of the cyclonic separating drum 310 and communicates with the tangential air duct 320. A spiral rise angle λ of the curve duct 330 is greater than a half cone angle a of an inverted cone drum 312 of the cyclonic separating drum 310, so that after the rotating airflow enters the curve duct 330, a direction of a centripetal force of the rotating airflow is changed to above a side of a direction of a support force of a drum wall of the cyclonic separating drum 310.

The cyclonic separating drum 310 includes a cylindrical drum 311 and an inverted cone drum 312. A bottom of the cylindrical drum 311 communicates with an upper portion of the inverted cone drum 312, and an upper portion of the cylindrical drum 311 is an open end 3111 which is convenient for assembling an overflow drum 340. A side edge of the cylindrical drum 311 is provided with an opening 3112 with which the tangential air duct 320 communicates to realize a tangential connection between the tangential air duct 320 and the cylindrical drum 311. A wide opening end 3121 in the upper portion of the inverted cone drum 312 is connected to a lower portion of the cylindrical drum 311 so that the cylinder drum 311 communicates with the inverted cone drum 312. A narrow opening end 3122 in a lower portion of the inverted cone drum 312 is a dust discharge port for allowing separated particles to be discharged therethrough.

The cyclonic separator 300 further includes the overflow drum 340 which is arranged in the upper portion of the cyclonic separating drum 310 about a same axis 350 to serve as an exhaust outlet to allow the separated airflow to leave the cyclonic separating drum 310. The overflow drum 340 is inserted through the open end 3111 of the cylindrical drum 311 and is arranged coaxially with the cylindrical drum 311.

It should be noted that when a ratio V²/R of a high-speed rotating airflow and material velocity V to a rotating radius R is much greater than a gravity acceleration g, the centripetal force M*V²/R of pollen-grade particles is much greater than gravity Mg of the material itself. In order to facilitate analysis, the influence of particle gravity is ignored.

When the airflow is rotating, under the circumstance of ignoring the influence of gravity, the particles in the airflow are only subjected to a support force N (a resultant force, F_{N}) provided by a drum wall. Because of the presence of rotating motion, the support force N is inevitably decomposed into a centripetal force (a first component force, F₁, F₁′) perpendicular to the rotating axis 350, the first component force is used to maintain a high-speed rotation motion of the particles and a direction of the first component force is perpendicular to the airflow rotating center axis 350. Since the support force F_{N} is perpendicular to a drum wall of the inverted cone drum 312, according to decomposition of vectors of the force, in order to maintain the balance of the vectors of the support force F_{N} and the centripetal force F₁ and F₁′, another component force (a second component force) and the centripetal force F₁ and F₁′ certainly straddle separately on both sides of the support force N to ensure the balance of the decomposition of the resultant force.

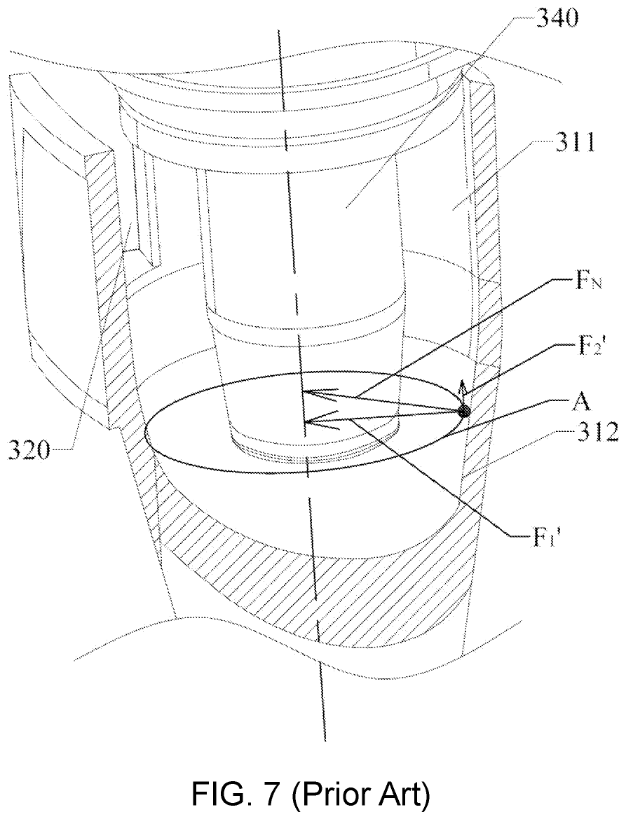

Referring to FIG. 7, before the curve duct 330 is provided, a rotating plane A of a rotating airflow at a certain place is perpendicular to the axis 350 of the cyclonic separating drum 310, and the direction of the centripetal force (the component force F₁′) does not change, i.e., pointing to the center of the rotating plane A and below the direction of the support force F_{N} of the drum wall, an included angle between the centripetal force F₁′ and the support force F_{N} of the drum wall is θ. Then, according to the balance of the decomposition of the resultant force, a component force F₂′ in balance with the component force F₁′ is always upward. It can be understood that, under this stress, the particles rotating at high speed do not suffer from any traction power that may discharge the particles downwards from the inverted cone drum 312. In other words, there is no acting force to discharge the particles from the cyclonic separating drum 310. In this case, the particles that cannot be discharged can only accumulate on the drum wall of the cyclonic separating drum 310.

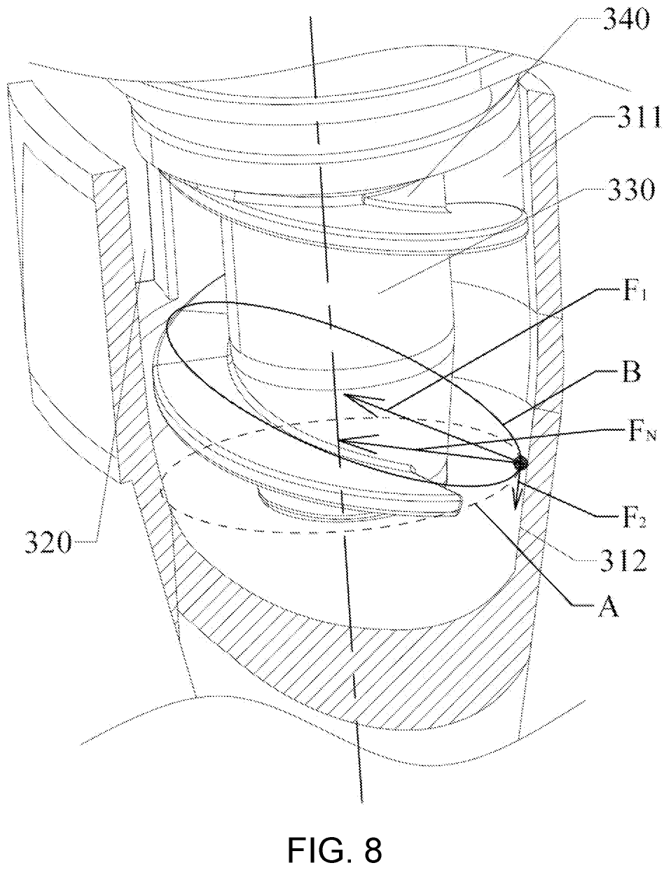

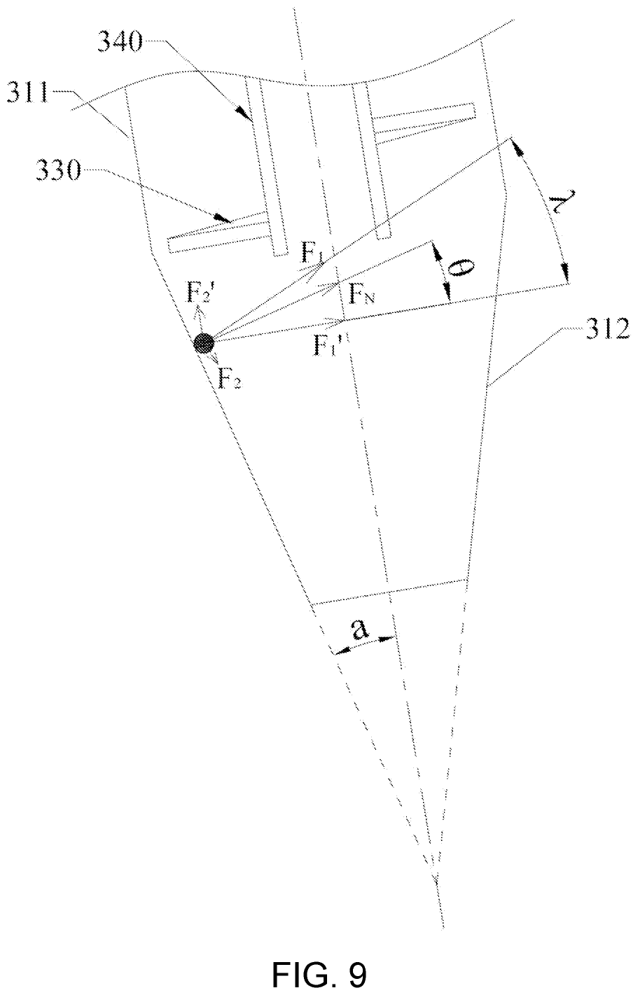

Referring to FIGS. 8 and 9, when the curve duct 330 is provided, the airflow flows out from a tangential air outlet 325 of the tangential air duct 320 with an airflow guide path to form a rotating airflow along the drum wall of the cylindrical drum 311. Since the tangential air outlet 325 corresponds to an entrance 331 of the curved duct 330, when the rotating airflow is formed, the rotating airflow enters the curved duct 330 that has a centripetal force redirection effect. Due to the curved duct 330 and limitations that the spiral rise angle λ is greater than the half cone angle a of the inverted cone drum 312, after the rotating airflow enters the inverted cone drum 312 through an exit 332 of the curved duct 330, the direction of the centripetal force of the rotating airflow deflects from an original direction perpendicular to the rotating axis 350 and forms an upward included angle with the direction of the support force F_{N} of the drum wall of the inverted cone drum 312. It should be understood that by setting the redirecting duct, an airflow rotating plane B forming an upward included angle (being the spiral rise angle λ) with the direction of the centripetal force F₁′ without the redirecting duct is provided in a three-dimensional space, that is, the direction of the centripetal force F₁ of the particles in the rotating airflow is changed to above the support force F_{N} provided by the drum wall of the inverted cone drum 312. Similarly, according to the principle of mechanical stress analysis, the particles in the rotating airflow still only suffer from the support force F_{N} (the resultant force) provided by the drum wall of the inverted cone drum 312, the first component force of the support force F_{N} is the centripetal force F₁ that maintains a high-speed rotation motion of the particles, the direction of the centripetal force F₁ is changed from the direction perpendicularly pointing to the airflow rotating center axis 350 to an airflow rotating plane in the direction forming the upward included angle in the three-dimensional space. Since the support force F_{N} is perpendicular to the drum wall of the inverted cone drum 312, according to the decomposition of the vectors of the force, in order to maintain the balance of the vectors of the support force F_{N} of the resultant force and the centripetal force F₁, inevitably, the other component force F₂ and the centripetal force F₁ respectively straddle on both sides of the support force F_{N} of the resultant force. Thus, after the rotating airflow flows through the redirecting duct, the direction of the other component force F₂ applied to the particles in the rotating airflow is downward. It can be understood that under the stress, the particles rotating at a high speed move downward under the traction of a downward component force. Therefore, inevitably, the particles separated from the airflow can be discharged from the inverted cone drum 312 to the outside of the dust discharge port.

In this way, the cyclonic separator 300 of the present disclosure can effectively discharge the separated particles to the outside of the dust discharge port timely and quickly through a combination of the tangential air duct 320 and the redirecting duct, not only solve the technical problem described in the background, but also avoid possibility of back mixing and diffusion caused by the accumulated particles, and meanwhile ensure that the cyclonic separating drum is in a clean state without particle accumulation to help to improve the separation and purification effect as well as prolong the service life. If there is no tangential air duct 320, when a lead of the redirecting duct is less than one lead, not only can a cyclone not be formed, but also there is a possibility that the airflow is not separated and is directly sucked away through the overflow drum 340. When the lead of the redirecting duct is larger than one lead or even more, it only plays a role in forming a cyclone, and does not impose any traction effect on the rapid discharge of the accumulated particles.

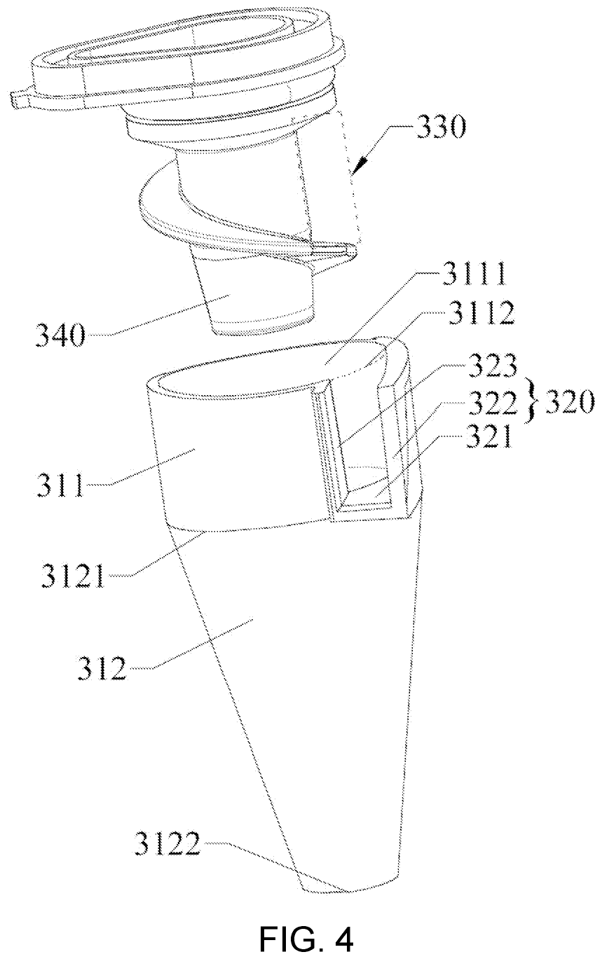

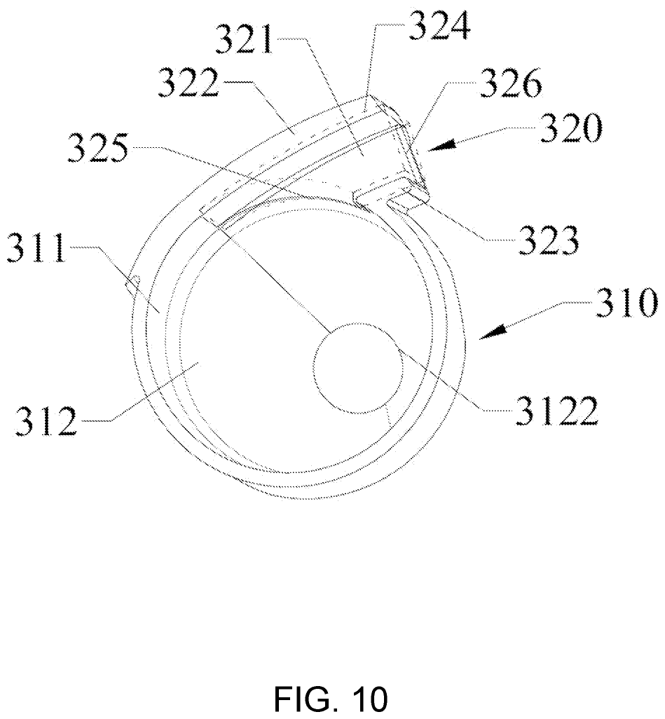

Referring to FIGS. 4 and 10, the tangential air duct 320 includes a lower wall 321 and an outer side wall 322 and an inner side wall 323 respectively connected to both sides of the lower wall 321. An air duct groove 324 with a certain distance, i.e., the airflow guide path, is formed by two side walls (the inner side wall 323 and the outer side wall 322) and the lower wall 321 to guide the air with particles into the airflow consistent with the direction of the tangential air duct 320. One end of the air duct groove 324 is connected to the opening 3112 in the side edge of the cylindrical drum 311 as the tangential air outlet 325, the outer side wall 322 of the tangential air duct 320 is connected with one side of the opening 3112, and the inner side wall 323 is connected with the other side of the opening 3112 and is tangent to the side edge of the cylindrical drum 311, so that the airflow consistent with the direction of the tangential air duct 320 tangentially enters the cylindrical drum 311 of the cyclonic separating drum 310 to form the rotating airflow.

Referring to FIGS. 4-6, the entrance 331 of the curved duct 330 corresponds to the tangential air outlet 325 of the tangential air duct 320, which can be understood as that the entrance 331 is located in an extending region of the tangential air duct 320. Further, a height of the tangential air duct 320 is set corresponding to a width of the curved duct 330, and a width of the tangential air duct 320 is set corresponding to a distance between the overflow drum 340 and the cyclonic separating drum 310. The corresponding herein may be understood as being equal or being slightly smaller. Such a design mainly satisfies a direct corresponding communication between the tangential air outlet 325 of the tangential air duct 320 and the curved duct 330, which reduces the energy loss caused by an unnecessary airflow rotating path.

As an embodiment, the outer side wall 322 of the tangential air duct 320 may be set to be a planar side wall and is tangent to the side edge of the cylindrical drum 311 of the cyclonic separating drum 310, and the inner side wall 323 of the tangential air duct 320 may be set to be a planar side wall or a curved side wall. As another embodiment, the outer side wall 322 of the tangential air duct 320 may be set to be a curved side wall, and is tangent to the side edge of the cylindrical drum 311 of the cyclonic separating drum 310, and the inner side wall 323 is a planar side wall or a curved side wall.

Further, the entrance 331 of the curved duct 330 corresponds to the tangential air outlet 325 of the tangential air duct 320 to reduce unnecessary rotating paths to further reduce stress loss. In some embodiments, the exit 332 of the curved duct 330 is provided corresponding to a connection 313 of the cylindrical drum 311 and the inverted cone drum 312. In some other embodiments, the exit 332 of the curved duct 330 may also be provided corresponding to the upper portion of the inverted cone drum 312. By such an arrangement in this way, the rotating airflow may directly enter the inverted cone drum 312 after exiting from the exit 332.

The curved duct 330 is located in a region between the cyclonic separating drum 310 and the overflow drum 340. In some embodiments, the curved duct 330 may be arranged on the cyclonic separating drum 310. In some embodiments, the curved duct 330 may be arranged on the overflow drum 340, i.e., on the outer wall of the overflow drum 340. In some other embodiments, the curved duct 330 is suspended between the cyclonic separating drum 310 and the overflow drum 340 by a support. In order to facilitate manufacturing and assembling, the curved duct 330 may be directly integrated on the cyclonic separating drum 310. More preferably, the curved duct 330 may be formed on the outer wall of the overflow drum 340 to avoid complexity of the structure of the cyclonic separating drum 310, and the curved duct 330 formed on the outer wall of the overflow drum 340 is more convenient to manufacture and assemble and is lower in cost compared with that formed in the overflow drum 340.

In the present disclosure, the curved duct 330 is not mainly used to form a cyclonic airflow (also called a whirling airflow or a rotating airflow) but is used to change the direction of the centripetal force of the rotating airflow, and a spiral lead of the curved duct 330 is unlike that of a spiral duct forming the cyclonic airflow, which is the more, the better. In some embodiments, the curved duct 330 is set to have a lead less than one, such as 2/3 lead, 1/2 lead, 1/3 lead, 1/4 lead, 1/8 lead or 1/10 lead. In some embodiments, the curved duct 330 may be further set to have more than one lead. In specific implementation, appropriate adjustment may be made according to an insertion depth of the overflow drum 340 into the cyclonic separating drum 310. In order to ensure the redirection effect, the curved duct 330 is preferably set to have at least 1/4 lead, that is, the rotating airflow flows through the curved duct 330 with at least 1/4 lead and is discharged into the inverted cone drum 312. Preferably, the curved duct 330 is preferably set to have 1/4 lead or more and one lead or less, and more preferably, 1/4 lead or more and 1/2 lead or less.

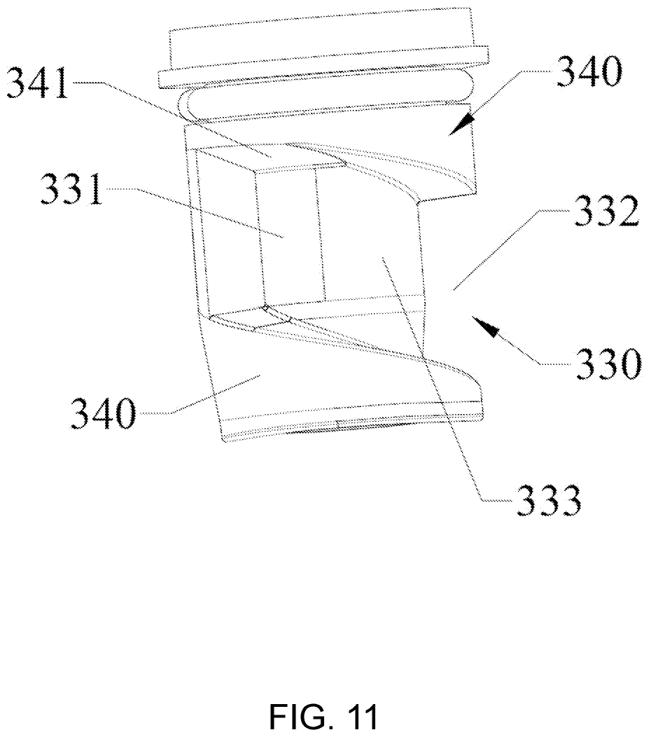

Referring to FIGS. 11-13, the curved duct 330 arranged on the outer wall of the overflow drum 340 is taken as an example for detailed description.

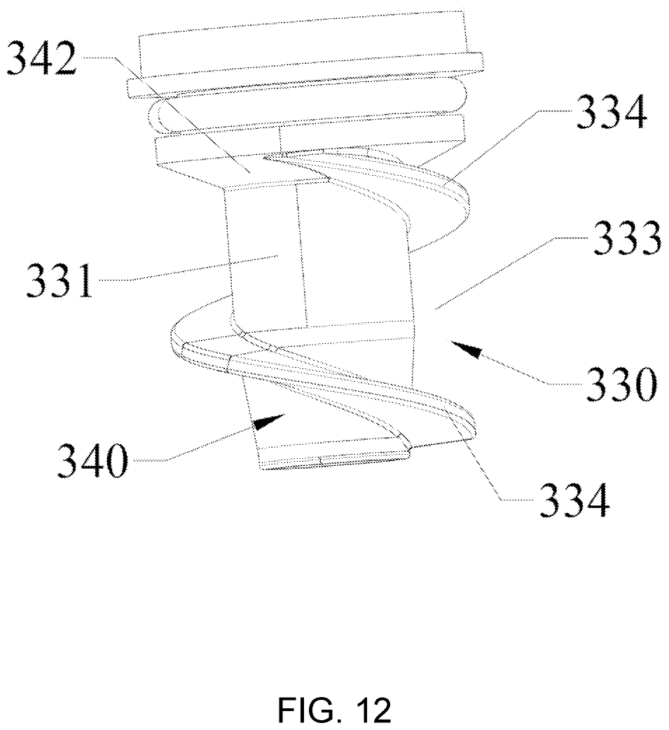

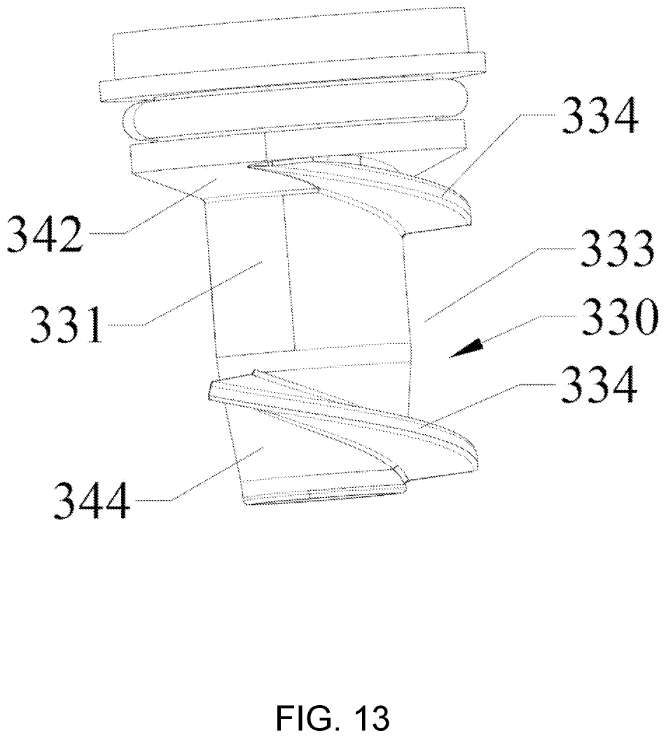

In some embodiments, as shown in FIG. 11, the curved duct 330 may be a groove-shaped duct 333 that is inwardly concave and spirally formed in the outer wall of the overflow drum 340, and the entrance 331 of the curved duct 330 is provided corresponding to the tangential air outlet 325 of the tangential air duct 320. In some embodiments, as shown in FIGS. 12 and 13, the curved duct 330 is the groove-shaped duct 333 which is formed between curved ribs 334 protruding outwardly from the outer wall of the overflow drum 340 and is spirally formed, and the entrance 331 of the curved duct 330 is provided corresponding to the tangential air outlet 325 of the tangential air duct 320. The curved ribs 334 may be single-head spiral ribs, as shown in FIG. 12, that is, one spiral rib is arranged on the outer wall of the overflow drum 340, and the groove-shaped duct 333 begins to be formed after one lead of one spiral rib. Preferably, a first lead herein may serve as the entrance 331. The curved ribs 334 may also be multi-head single-screw spiral ribs, as shown in FIG. 13, that is, a plurality of spiral ribs with the same spiral direction are provided on the outer wall of the overflow drum 340. It can be understood that heads of the plurality of the spiral ribs may be provided corresponding to the tangential air outlet 325, that is, the head of one of the spiral ribs is located on the extending plane of an upper wall (which can also be understood as a plane formed by connection of tops of the two side walls)of the tangential air duct 320, and the head of the second spiral rib adjacent to this spiral rib is located on the extending plane of the lower wall 321 of the tangential air duct 320. By an arrangement in this way, the heads of the multi-head spiral ribs at the head may serve as the entrance 331, and exactly correspond to the tangential air outlet 325 of the tangential air duct 320. The heads of the multi-head single-screw spiral ribs may also be arranged above the tangential air outlet 325, but it is only required to satisfy that a spiral groove formed by the multi-head single-screw spiral ribs corresponds to the tangential air outlet 325 of the tangential air duct 320.

Further, referring to FIGS. 3 and 11, the cyclonic separator 300 further includes a diversion inclined wall 341 which is provided corresponding to the upper portion of the tangential air duct 320. It can be understood that the diversion inclined wall 341 is provided corresponding to the extending plane of the upper wall of the tangential air duct 320. By means of such a design, the diversion inclined wall 341 prevents part of the rotating airflow flowing through the tangential air duct 320 from rotating on the drum wall at an upper end of the cylindrical drum 311 to avoid forming an “upper dust ring” which not only causes energy loss but also greatly interferes with the separation effect. Preferably, the diversion inclined wall 341 is arranged on the upper portion of the outer wall of the overflow drum 340. In order to facilitate manufacturing, the diversion inclined wall 341 extends circumferentially to form a diversion inverted cone platform 342, as shown in FIGS. 12 and 13. Specifically, an obtuse angle is formed between the diversion inclined wall 341 and the outer wall of the overflow drum 340, which helps to guide the rotating airflow downwards to enter the curved duct 330. In some embodiments, arranging the curved duct 330 and the diversion inclined wall 341 on the outer wall of the overflow drum 340 is taken as an example, and the upper end of the curved duct 330 is connected with the diversion inverted cone platform 342, e.g., the upper end of the entrance 331 of the groove-shaped duct 333 or the head of the single-head spiral rib or the head of the uppermost spiral rib of the multi-head single-screw spiral ribs is connected with the diversion inverted cone platform 342. In some preferred embodiments, the connection 313 of the curved duct 330 and the diversion inverted cone platform 342 is located in the extending region of the tangential air duct 320 to avoid or reduce the existence possibility of the “upper dust ring”, and at the same time, to reduce the escape of the rotating airflow which is not separated and to help guide the rotating airflow to downward enter the curved duct 330.

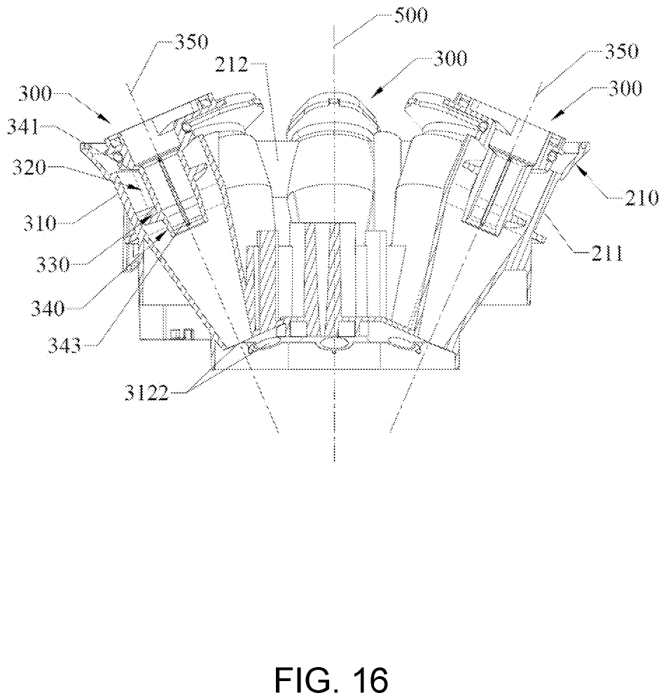

Referring to FIG. 16, the inner wall of the overflow drum 340 is provided with a plurality of flat and long spoiler ribs 343 axially. Preferably, elongated sides of the spoiler ribs 343 are axially connected to the inner wall of the overflow drum 340. Compared with existing arc columnar spoiler ribs 343, the flat and long spoiler ribs 343 can more effectively interfere with an internal rotation state of the airflow to make the airflow be in a linear movement state more quickly and be discharged rapidly. In some preferred embodiments, bottoms of the spoiler ribs 343 do not extend to the bottom of the overflow drum 340, which not only avoids that the spoiler ribs 343 interfere with the airflow not entering the overflow drum 340 to cause the airflow not to become straight quickly to be discharged directly but to flow towards other directions to influence the separation effect, but also does not influence an air inflowing space at the bottom of the overflow drum 340, ensuring that the internal rotating airflow smoothly enters the bottom of the overflow drum 340 and then becomes straight to be discharged quickly through inference from the flat and long spoiler ribs 343.

The bottom of the overflow drum 340 extends to the upper portion of the inverted cone drum 312 of the cyclonic separating drum 310. It can be understood that the bottom of the overflow drum 340 is located at the connection 313 of the cylindrical drum 311 and the inverted cone drum 312 or below the connection 313. In this embodiment, preferably, the bottom of the overflow drum 340 extends into the inverted cone drum 312 and is located in the upper portion of the inverted cone drum 312. In some preferred embodiments, a length of the overflow drum 340 is 0.3 to 0.4 times a length of the cyclonic separating drum 310, which is not limited thereto. The length of the overflow drum 340 is understood to be a distance between the inverted diversion cone platform 342 and the bottom of the overflow drum 340, or a distance from a part parallel and level to the upper wall of the tangential air duct 320 to the bottom of the overflow drum 340.

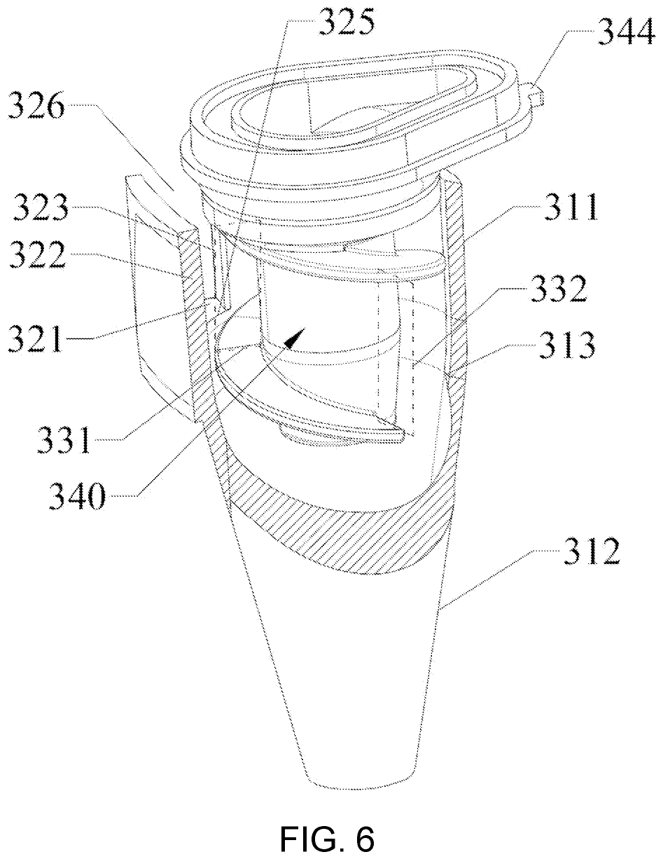

Referring to FIG. 6, the upper portion of the overflow drum 340 is provided with a positioning portion 344 so that the curve duct 330 communicates with the tangential air duct 320 correspondingly. Through the design of the positioning portion 344, when being assembled, the overflow drum 340 may be quickly positioned and after positioning, it may be ensured that the curve duct 330 may communicate with the tangential air duct 320 correspondingly, thereby reducing the assembling difficulty and improving the assembling accuracy. It is can be understood that the positioning portion 344 may be designed to cooperate with the cylindrical drum 311. For example, the positioning portion 344 is configured as a buckle, and is buckled into a predetermined blind hole 231 outside the drum wall of the cylindrical drum 311 by the buckle, but it is not limited hereto.

It should be realized that the tangential air duct 320 may be integrally formed with the cyclonic separating drum 310, the curved duct 330 is integrally formed with the overflow drum 340, and the diversion inverted cone platform 342 and the positioning portion 344 are also integrally formed with the overflow drum 340. Such a design makes the cyclonic separator 300 easy to manufacture and assemble.

As an embodiment of the arrangement of the cyclonic separators 300, the plurality of cyclonic separators 300 may be arranged in a ring shape to form a set of cyclonic separator rings 220. The cyclonic separators 300 in the cyclonic separator rings 220 are arranged circumferentially along a ring wall 211 of a cyclonic separator support 210 of the cyclonic separating apparatus. In some embodiments, tangential air ducts 320 of the cyclonic separators 300 are arranged next to the ring wall 211 of the cyclonic separator support 210. Preferably, the ring wall 211 of the cyclonic separator support 210 serves as an outer side wall 322 of each tangential air duct 320. By such a structural design, the airflow separated from the upstream cyclonic separating assembly 100 communicating with the downstream cyclonic separating assembly 200 mainly flows downstream along the ring wall 211 of the cyclonic separator support 210, and may directly be redirected to enter the tangential air ducts 320 after exiting from air introducing ports 400 (that are downstream outlets of the air guide path), thereby shortening the movement path of the airflow to reduce energy loss. In some embodiments, the tangential air ducts 320 of the cyclonic separators 300 are not arranged next to the ring wall 211 of the cyclonic separator support 210. It can be understood that the air inlets 326 of the tangential air ducts 320 are formed far away from the ring wall 211 of the cyclonic separator support 210.

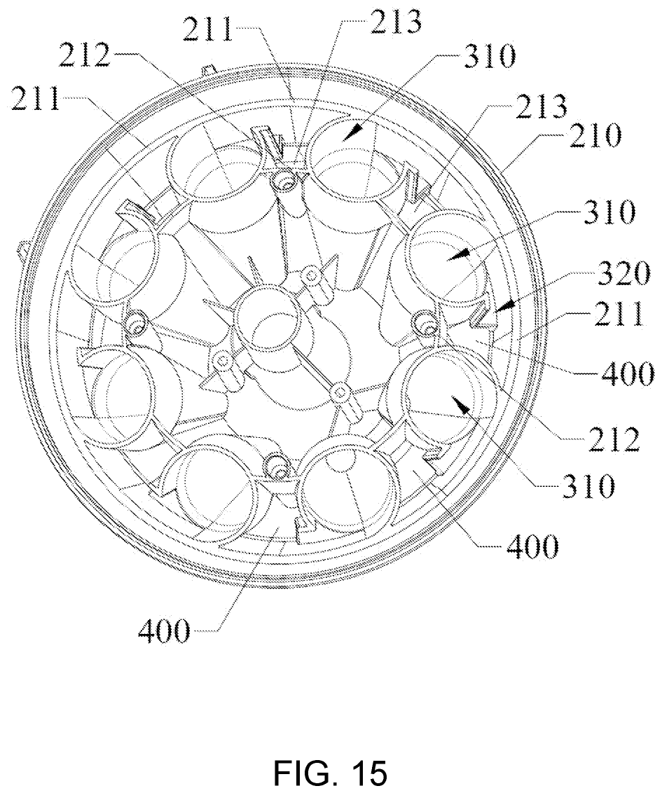

In one of the embodiments, referring to FIG. 15, each of the cyclonic separators 300 of the same one cyclonic separator ring 220 may correspond to one air introducing port 400. That is, one tangential air duct 320 corresponds to one air introducing port 400, and except for the tangential air ducts 320, regions of the air introducing ports 400 are not blocked so as to increase the air introducing quantity. Meanwhile, the tangential air ducts 320 and the air introducing ports 400 are in one-to-one correspondence, thus avoiding collisions of multiple airflows to avoid forming turbulence which mainly causes low efficiency in airflow rotation to further be not beneficial for separation of dust particles from the airflow. In another embodiment, two of the cyclonic separators 300 of the same one cyclonic separator ring 220 may correspond to one air introducing port 400. That is, one air introducing port 400 corresponds to the two tangential air ducts 320, and except for the tangential air ducts 320, the regions of the air introducing ports 400 are not blocked so as to increase the air introducing quantity. Furthermore, the regions on the front sides of the air inlets 326 of the tangential air ducts 320 are not blocked, that is, the airflow can enter the air inlets 326 just after being redirected once at the air introducing ports 400 to avoid that the airflow is redirected for the second time after entry from the air introducing ports 400 and then enters the air inlets 326 again, thereby reducing the energy loss caused by the unnecessary movement path of the airflow.

As another embodiment of the arrangement of the cyclonic separators 300, the plurality of cyclonic separators 300 may be arranged in parallel with each other to form multiple sets of cyclonic separator rings 220, and the multiple cyclonic separators 300 of each set of cyclonic separator rings 220 are circumferentially arranged in a ring shape, and the adjacent sets of cyclonic separator rings 220 are nested or partially embedded in concentric circles. Taking two sets of cyclonic separator rings 220 for example, the first set of cyclonic separator rings 220 is much large in quantity to form a relatively large ring-shaped cyclonic separator ring 220, and the second set of cyclonic separator rings 220 is partially joined in or embedded into the first set of cyclonic separator rings 220. It can be understood that, in a top view, the first set of cyclonic separator rings 220 surrounds the second set of cyclonic separator rings 220, and heights of different sets of cyclonic separator rings 220 may be designed to be the same or different based on actual conditions. In order to further optimize the structure and avoid increasing the volume of the cyclonic separating apparatus, preferably, the smaller ring-shaped cyclonic separator rings 220 are inserted into inner rings of the larger ring-shaped cyclonic separator rings 220 to form a state that the smaller ring-shaped cyclonic separator rings are stacked above the larger ring-shaped cyclonic separator rings in an axial direction, and outer rings of the smaller ring-shaped cyclonic separator rings are partially in contact with or close to the inner rings of the larger ring-shaped cyclonic separator rings.

It should be noted that the function of the plurality of cyclonic separators 300 is that in a certain plane, the more the cyclonic separators 300 are, the smaller the radiuses of the separators 300 are. According to a centripetal force formula F=M*V²/R, it can be seen that the smaller the radius is, the greater the centripetal force is, and the greater the centripetal force is, the better the separation effect of substances in different masses in the airflow is.

Preferably but unlimitedly, an axis 350 of each cyclonic separating drum 310 is provided obliquely with respect to a longitudinal center axis 500 of the cyclonic separating apparatus. It should be noted that not all the cyclonic separators 300 in the same set of cyclonic separator rings 220 need to be inclined at the same angle with respect to the longitudinal center axis 500 of the cyclonic separating apparatus. That is, the cyclonic separators 300 in the same set of cyclonic separator rings 220 may be inclined at different angles with respect to the longitudinal center axis 500 of the cyclonic separating apparatus. Similarly, not all the cyclonic separators 300 in the same set of cyclonic separator rings 220 need to have the same internal dimension.

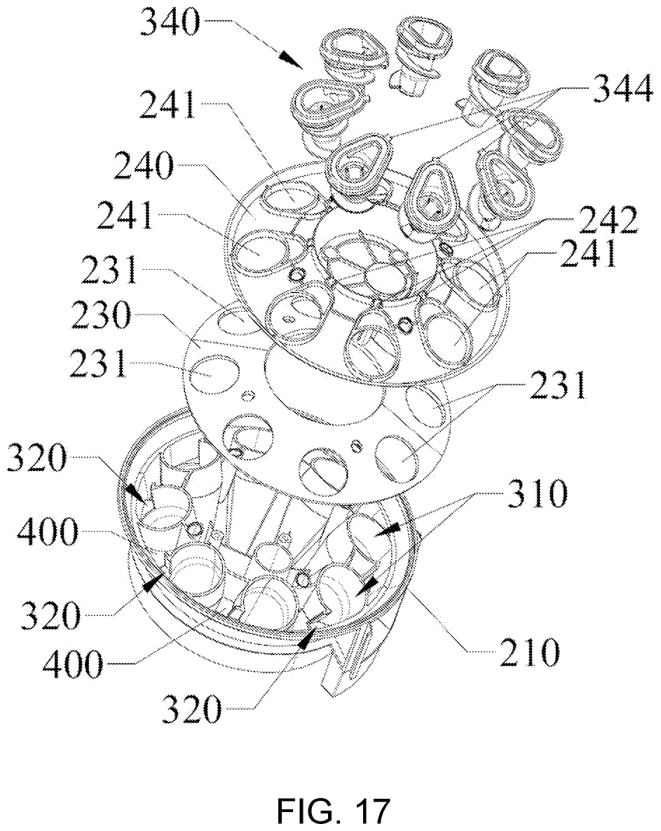

Referring to FIGS. 17-19, the downstream cyclonic separating assembly 200 further includes a sealing element 230 arranged above the cyclonic separator rings 220. In order to facilitate the assembly of the downstream cyclonic separating assembly 200 and further simplify the structure as well as lighten the cyclonic separating apparatus, upper ends of the tangential air ducts 320 are opened, and an upper end of the cyclonic separator support 210 is also opened. When assembled, the sealing element 230 is pressed above the cyclonic separator rings 220, i.e., seals at least the upper ends of the tangential air ducts 320 and upper ends of the air introducing ports 400. Preferably, the sealing element 230 is further provided with a plurality of holes 231 which prop against outer sides of overflow drums 340 in a sealing manner. It can be understood that the sealing element 230 is provided with the holes 231 to make way for the overflow drums 340 while sealing remaining parts of the cyclonic separator rings 220.

Referring to FIGS. 17-19, the downstream cyclonic separating assembly 200 further includes a cover plate member 240 arranged on the sealing element 230 to press and limit the sealing element 230. It should be noted that in specific implementation, there may be only the cover plate member 240, or a combination of the sealing element 230 and the cover plate member 240 may be used to enhance airflow tightness and reduce airflow escape. Further, the cover plate member 240 is further provided with a plurality of assembling holes 241 corresponding to open ends 3111 of the cyclonic separators 310 so as to insert the overflow drums 340 into the assembling holes 241, so that the overflow drums 340 are partially located in the cyclonic separating drums 310. In order to improve the sealing effect, sealing rings 345 are further arranged on the outer sides, above the sealing element 230, of the overflow drums 340. Preferably, positioning members 242 are further arranged on side edges of the assembling holes 241, and are used to position the overflow drums 340 so that the curve ducts 330 correspondingly communicate with the tangential air ducts 320 after the overflow drums 340 are assembled. Specifically, the positioning members 242 may cooperate with positioning portions 344 of the overflow drums 340 to form a positioning structure provided between the overflow drums 340 and the cover plate member 240.

The positioning structure includes at least one of a concave-convex positioning structure, a buckle type positioning structure and an elastic fastener type positioning structure, but it is not limited thereto, and it is only required to satisfy quick alignment and positioning. Through the combination of the positioning members 242 and the positioning portions 344, the overflow drums 340 can be quickly and effectively positioned and limited when being assembled, so that the curve ducts 330 communicate correspondingly with the tangential air ducts 320 without a need of fastening methods such as screws, which may appropriately lighten the cyclonic separating apparatus while reducing the assembly processes and the difficulty in assembly alignment.

In some embodiments, in the concave-convex positioning structure, the positioning members 242 are grooves, and the positioning portions 344 are projections. During assembly, after the overflow drums 340 are inserted into the assembling holes 241, the overflow drums 340 are assembled and positioned when the projections are placed correspondingly in the grooves. In some embodiments, in the concave-convex positioning structure, the positioning members 242 are L-shaped clamping grooves, the positioning portions 344 are projections. During assembly, after the overflow drums 340 are inserted into the assembling holes 241, the projections are correspondingly placed in vertical grooves of the clamping grooves, and then the overflow drums 340 are rotated to make the projections enter lateral grooves of the clamping grooves, so that the overflow drums 340 are assembled and positioned. Compared with positioning members 242 which are only vertical grooves, the positioning members 242 in this embodiment may further restrict up and down movements of the overflow drums 340 to avoid affecting assembling precision and efficiency. In some embodiments, in the buckle type positioning structure, the positioning members 242 are clamping positions and the positioning portions 344 are clamping tables, and during assembly, after the overflow drums 340 are inserted into the assembling holes 241, the clamping tables are correspondingly placed in the clamping positions, so that the overflow drums 340 are assembled and clamped to avoid rotation. In some embodiments, in an elastic fastener type positioning structure, the positioning members 242 is hooks, and the positioning portions 344 are upper end edges of the overflow drums 340. During assembly, after the overflow drums 340 are inserted into the assembling holes 241, the upper end edges of the overflow drums 340 pass through the hooks, and after the hooks bounce off and the overflow drums 340 are in place, the hooks return to hook the upper end edges of the overflow drums 340. More preferably, the upper end edges of the overflow drums 340 are provided with hook grooves, which cooperate with the hooks to further clamp the overflow drums 340 to avoid rotation of the overflow drums 340. It should be noted that the specific structures of the above positioning members 242 and positioning portions 344 may be exchanged.

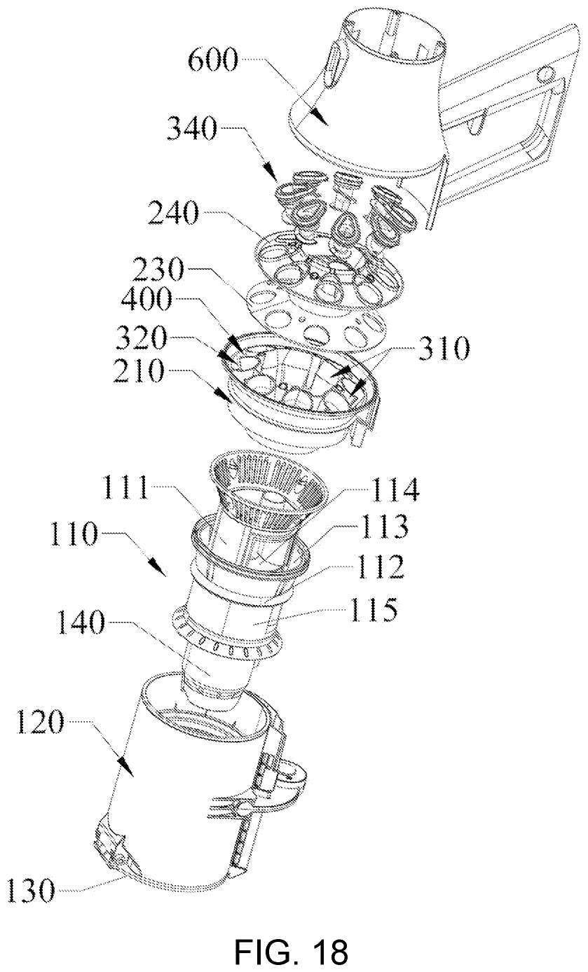

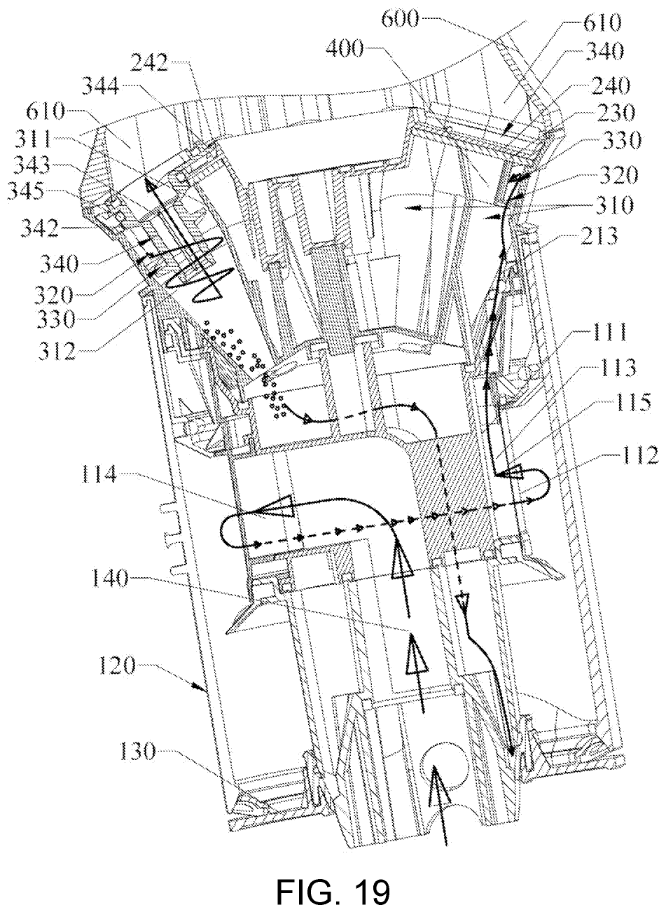

Referring to FIGS. 18 and 19, the cyclonic separating apparatus further includes a cyclonic separator cover 600 connected to an upper portion of the cyclonic separator support 210. The cyclonic separator cover 600 is provided with a cyclonic separator outlet pipe 610. Specifically, an edge of the cyclonic separator cover 600 props against the upper edge of the cyclonic separator support 210 in a sealing manner, and the cyclonic separator outlet pipe 610 abuts against the cover plate member 240 and/or the overflow drums 340, and preferably but unlimitedly, abuts against the overflow drums 340 to facilitate a rapid discharge of separated clean airflows. Meanwhile, the positions of the overflow drums 340 with respect to the cyclonic separating drums 310 are pressed and limited to avoid the problems of poor separation effect caused by loosening and movement of the overflow drums 340 during the use, transfer and the like of the cyclonic separating apparatus. The clean airflows discharged from the overflow drums 340 are combined into one airflow in the cyclonic separator cover 600 to be discharged from and exit the cyclonic separating apparatus.

By arrangement of the above sealing element 230, the cover plate member 240 and the positioning structure, the configuration automatically provides good alignment and reliable sealing between the overflow drums 340 and the cyclonic separating drums 310 as well as the air introducing ports 400 as well as good alignment between the tangential air ducts 320 and the curved ducts 330.

It should be realized that the tangential air ducts 320 and the cyclonic separating drums 310 of the cyclonic separators 300, and the cyclonic separator support 210 are integrally formed into a main body of the downstream cyclonic separating assembly 200, and the air introducing ports 400 are formed by enclosing of the adjacent cyclonic separating drums 310. In specific implementation, the main body of the downstream cyclonic separating assembly 200 and the overflow drums 340 are separately manufactured so as to simplify manufacturing and assembling of the cyclonic separating apparatus.

Referring to FIGS. 18 and 19, the upstream cyclonic separating assembly 100 includes a dust control housing 120 carrying a separation drum 110 and a dust collection cover 130. The separation drum 110 includes an inner drum 111 and an outer drum 112 nested about the same axis 350. A tangential inlet 114 is formed in an side wall of the inner drum 111, one end of the tangential inlet 114 communicates with a vertical air inlet duct 140 and the other end of the tangential inlet 114 communicates with the outside of the outer drum 112. That is, a dirty airflow enters through the vertical air inlet duct 140, is redirected through the tangential inlet 114 to enter an upstream separation region between the outer drum 112 and the dust control housing 120. Preferably, a filter mesh 115 is arranged on a side wall of the outer drum 112 to further prevent part of the particles from entering the outer drum 112. The vertical air inlet duct 140 is arranged in the inner drum 111. The dust collection cover 130 is detachably connected to a lower portion of the dust control housing 120. Preferably, the dust collection cover 130 is provided with an escape space to facilitate the passage of the vertical air inlet duct 140. In specific implementation, the dirty airflow enters from the vertical air inlet duct 140, and enters the upstream separation region through the tangential inlet 114, and the dirty airflow carrying particles is conveyed in a direction tangential to a side wall of the dust control housing 120 to the separation region of the upstream cyclonic separating assembly 100 to form a rotating airflow, the rotating spiral airflow causes part of larger particles carried in the airflow to be separated from the airflow, and the separated airflow flows through the filter mesh 115 and then enters a compartment 113 between the outer drum 112 and the inner drum 111. Further, a lower portion of the side wall of the dust control housing 120 and the dust collection cover 130 together form a collector for particles such as dirt and dust separated by the upstream cyclonic separating assembly 100. The dust control housing 130 is detachably connected to the side wall of the dust control housing 120. The collector may discharge all of the separated particles by a user opening a base.

An upper portion of the dust control housing 120 is connected to the cyclonic separator support 210. Preferably, a lower side edge of the cyclonic separator support 210 leans on and is positioned at an upper edge of the dust control housing 120. An upper portion of the separation drum 110 is connected to the cyclonic separator support 210. Specifically, the ring wall 211 of the cyclonic separator support 210 and an inner sealing ring 212 form an airflow guide cavity 213, i.e., the air guide path. The compartment 113 in the separation drum 110 is in a sealed communication with the airflow guide cavity 213 to provide a communication path between the upstream cyclonic separating assembly 100 and the downstream cyclonic separating assembly 200. More preferably, the compartment 113 is in communication with the airflow guide cavity 213 via a connecting cavity. The inverted cone drums 312 of the cyclonic separators 300 in the downstream cyclonic separating assembly 200 are arranged on a dust discharge passage communicating with the dust collection cover 130.

### Embodiment 2

A method for manufacturing the cyclonic separating apparatus described in Embodiment 1 includes the following steps. Manufacturing a first component, wherein the first component includes a cyclonic separator support 210, and a plurality of cyclonic separating drums 310 and tangential air ducts 320 arranged on the cyclonic separator support 210. The tangential air ducts 320 being in tangential communication with the cyclonic separating drums 310. Manufacturing a second component, wherein the second component includes a plurality of overflow drums 340 with curved ducts 330.

Further, the method for manufacturing the cyclonic separating apparatus further includes the step of assembling the first component and the second component through a cover plate member 240, i.e., assembling the overflow drums 340 in upper portions of the cyclonic separating drums 310 about the same axis 350. Using a positioning structure to position the second component in a predetermined position and/or orientation with respect to the first component, such that the curved ducts 330 of the overflow drums 340 correspondingly communicate with the tangential air ducts 320. Specifically, entrances 331 of the curved ducts 330 are set to be positioned at tangential air outlets 325 of the tangential air ducts 320. Exits 332 of the curved ducts 330 are set to be positioned at connections 313 of cylindrical drums 311 and inverted cone drums 312 or at upper portions of the inverted cone drums 312.

Further, the method for manufacturing the cyclonic separating apparatus further includes the step of assembling the downstream cyclonic separating assembly and the upstream cyclonic separating assembly.

### Embodiment 3

A cleaning appliance includes the above cyclonic separating apparatus of Embodiment 1 or the cyclonic separating apparatus manufactured by the manufacturing method of Embodiment 2. The appliance does not have to be a drum-type vacuum cleaner. The present disclosure is applicable to other types of vacuum cleaners, such as drum machines, wand type vacuum cleaners or hand-held vacuum cleaners.

In the description of the present disclosure, it should be understood that the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential” and the like indicate the orientation or positional relationship based on the orientation or positional relationship shown in the accompanying drawings, are only for the convenience of describing the present disclosure and simplifying the description, rather than indicating or implying that the device or component needs have a specific orientation, and needs to be configured and operated in the specific orientation, and therefore, cannot be construed as limiting the present disclosure.

In addition, the terms “first” and “second” are only used for descriptive purposes, and cannot be understood as indicating or implying relative importance or implicitly indicating the number of indicated technical features. Therefore, the features defined with the terms “first” and “second” may explicitly or implicitly include at least one of the features. In the description of the present disclosure, the term “a plurality of” means at least two, such as two, three, etc., unless otherwise definitely defined.

In the present disclosure, unless otherwise clearly specified and limited, the terms “install”, “join”, “connect”, “fix”, “communicate” and other terms should be understood in a broad sense. For example, it may be a fixed connection, a detachable connection or an integrated connection; it may be a mechanical connection, an electrical connection or possibility to communicate with each other; it may be a direct connection or an indirect connection through an intermediate medium; it may be an internal communication between two components or an interactive relationship therebetween, unless otherwise definitely defined. Those of ordinary skill in the art may understand specific meanings of the terms in the present disclosure according to specific circumstances.

Obviously, the embodiments described above are only part of the embodiments of the present disclosure, instead of all of them. The accompanying drawings show preferred embodiments of the present disclosure, but do not limit the protection scope of the present disclosure. The present disclosure may be implemented in many different forms. On the contrary, the purpose of providing these embodiments is to make the disclosure of the present application be understood more thoroughly and comprehensively. Although the present application has been described in detail with reference to the above embodiments, those skilled in the art can still modify the technical solutions described in the above specific embodiments, or equivalently replace some of the technical features. All the equivalent structures, which are made using the contents of the description and the accompanying drawings of the present application, and are directly or indirectly used in other related technical fields, still fall within the protection scope of the present application.

1. A cyclonic separating apparatus, comprising a downstream cyclonic separating assembly, which includes at least one cyclonic separator ring, wherein each cyclonic separator ring includes a plurality of cyclonic separators, each of the cyclonic separators comprises:
a cyclonic separating drum, having an upper side edge that communicates with a tangential air duct, wherein through the tangential air duct, air with particles is guided to form an airflow that is consistent with a direction of the tangential air duct and then tangentially enters the cyclonic separating drum to form a rotating airflow; and
a curved duct, arranged in an upper portion of the cyclonic separating drum and communicating with the tangential air duct, wherein a spiral rise angle of the curved duct is greater than a half cone angle of an inverted cone drum of the cyclonic separating drum, such that after the rotating airflow enters the curved duct, a direction of a centripetal force of the rotating airflow is changed to above a side of a direction of a support force of a drum wall of the cyclonic separating drum.

2. The cyclonic separating apparatus according to claim 1, wherein a lead of the curved duct is set to be less than one.

3. The cyclonic separating apparatus according to claim 1, wherein the tangential air duct has an airflow guide path.

4. The cyclonic separating apparatus according to claim 3, wherein an outer side wall of the tangential air duct is a planar side wall, and is tangent to a side edge of a cylindrical drum of the cyclonic separating drum; or, the outer side wall of the tangential air duct is a curved side wall, and is tangent to the side edge of the cylindrical drum of the cyclonic separating drum.

5. The cyclonic separating apparatus according to claim 4, wherein an inner side wall of the tangential air duct is a planar side wall or a curved side wall.

6. The cyclonic separating apparatus according to claim 1, wherein each of the cyclonic separators further comprises an overflow drum which is coaxially arranged in the upper portion of the cyclonic separating drum and serves as an exhaust outlet, and the curved duct is located in a region between the cyclonic separating drum and the overflow drum.

7. The cyclonic separating apparatus according to claim 6, wherein the curved duct is arranged on the drum wall of the cyclonic separating drum, or the curved duct is arranged on an outer wall of the overflow drum.

8. The cyclonic separating apparatus according to claim 6, wherein two side walls of the tangential air duct or extension surfaces of the tangential air duct are respectively tangent to the cyclonic separating drum and the overflow drum.

9. The cyclonic separating apparatus according to claim 1, wherein each of the cyclonic separators further comprises a diversion inclined wall corresponding to an upper portion of the tangential air duct.

10. A cleaning appliance comprising a cyclonic separating apparatus according to claim 1.
